(19) United States
(12) Patent Application Publication
(10) Pub. No.: US 2015/0120397 A1
(43) Pub. Date: Apr. 30, 2015

(54) GENERAL ENTERPRISE MODELING SYSTEM AND METHODOLOGY FOR CONSTRUCTING ENTERPRISE APPLICATIONS

(71) Applicant: Seetaramaiah VISSAPRAGADA, Hyderabad (IN)

(72) Inventor: Seetaramaiah VISSAPRAGADA, Hyderabad (IN)

(21) Appl. No.: 14/501,080

(22) Filed: Sep. 30, 2014

Related U.S. Application Data
(63) Continuation-in-part of application No. PCT/IN2013/000336, filed on May 27, 2013.

(51) Int. Cl. G06Q 10/06

(52) U.S. Cl. CPC G06Q 10/067
USPC 705/7.36

(57) ABSTRACT

The present disclosure provides a method and system for method of dynamically constructing an enterprise application for an enterprise. In one embodiment, a computer implemented method includes generating a business model for an enterprise based on a first set of parameters specific to the enterprise, and generating an interface model for the enterprise based on a second set of parameters specific to the enterprise. The method also includes dynamically constructing an enterprise application for the enterprise based on the business model and the interface model.

### CLAIM OF PRIORITY

This patent application claims priority from:

1) International Patent Application no. PCT/IN2013/000336 dated 27 May 2013; and
2) Indian Patent Application no. 2099/CHE/2012 dated 25 May 2012 and has been incorporated in its entirety by reference.

### FIELD OF TECHNOLOGY

The present disclosure generally relates to the field of enterprise applications, and more particularly relates to dynamically constructing and maintaining enterprise applications.

### BACKGROUND

Enterprise applications are software applications which facilitate execution of business transactions, storage and maintenance of a business database and management of business information systems, in line with the business vision, mission and strategies and as required by business process owners of an organization. The term ‘organization’ herein refers to a group of companies or a single company involved in conducting business.

Typically enterprise applications serve the following purposes for organizations:
Facilitate capture of relevant inputs and execution of business transactions;
Maintain the transaction records and other business information;
Provide a management information system for managing business operations as well as for operational and strategic decision support; and
Provide a robust, reliable and scalable technology framework to maintain the application, in line with changes in business environments.

Thus, enterprise applications provide the much desired “competitive edge” to companies through the deployment of technology-based systems.

Enterprise applications are constructed through custom-development for the specific business requirements of an organization. The traditional custom-development method produces enterprise applications to precisely suit the stated business requirements of the organization. However, the conventional custom development method suffers with several disadvantages. It involves the manual development of software and hence takes relatively longer durations, even when done by exceptionally talented teams. Usually there is a “reinventing of the wheel” for each organization, as reusing and editing of earlier made applications even partially, amounts to a substantial effort and time. The process is likely to take such long durations that typically business requirements undergo changes even during the course of the project. Maintenance of the enterprise application also becomes quite effort-some and costly as the organization depends on a small team having knowledge and skills for constructing the enterprise application. The impact of this risk is further multiplied as there is little or no documentation, no organization backing of the enterprise application for user trouble-shooting support, maintenance and for providing updates from time-to-time.

Another currently known enterprise application building process involves customizing an Enterprise Resource Planning (ERP) product to suit specific business requirements of an organization. Conventionally, enterprise applications are also effectively produced through customizing ERP products equipped with generalized business processes, a comprehensive set of functionalities and built-in best practices well-suited to the business. This method has several distinct advantages compared to custom-developed solutions including relatively shorter project durations, reasonably bug-free and reliable quality of software, continued support from product vendor, etc.

However, currently available ERP products are fairly generalized and hence applicable to most popular industries or businesses. Though these products are customizable through setting of parameters, at the software level, the unused arms of these products remain a live part of the total application and hence need constant maintenance.

Ideally, the size of the application is desired to commensurate with the actual need. This results in “small and simple solutions for small customers” and large and complex solutions for big customers. In spite of their large size, generalized design and customizable nature, the ERP products are “fixed” and inflexible” at some logical level, considering the fact that large code level customizations are undesirable during an ERP implementation. Often implementing consultants are seen having tough time choosing between the options of convincing and persuading users to use unwanted (not well-appreciated by users) facilities of the ERP product, and going through major customizations to remove the facilities/functionalities offered by the ERP product.

The size of the ERP product, the huge infrastructural and maintenance costs that it calls for, typically pose major problems to organizations of moderate size. The complexity of the solution and the concepts implemented also pose equally serious problems. Understanding and appreciating these concepts as well as assessing the suitability of these techniques/approaches to the requirements is the next major concern.

Striking a balance between the need for maintaining information and the actual utility or value derivable from the same makes the next major concern. Apparently, a significant benefit is derived by the business when and only when the utility of the information maintained is significantly higher than the costs of maintaining the same.

Latest and best practices of the world can be effectively adopted and prove to be worth their cost when they are—well-understood, well-assessed for their suitability to the business situation, well-implemented and the changes called for by them in business practices, are well-managed. If not, these practices could prove to be of negative impact to the business.

Moreover, improper change management has been the primary cause of a majority of failures in ERP implementation projects all over the world. Any best practice can be easily implemented quite successfully when the user states it as one of his primary requirements to implement the same. In such a case, the user is aware of the practice, appreciates its good results and enthusiastically awaits and supports its implementation. On the other hand, best practices introduced are being forced or imposed by the ERP product on the users. On top of this, he is inseparably attached to the present practice (his brain-child, in most cases). Hence, psychologically, the user is not ready to accept the change and hence opposes the same.

### SUMMARY

The present invention provides a method and system for method of dynamically constructing an enterprise application for an enterprise. In one aspect, a computer implemented method includes generating a business model for an enterprise based on a first set of parameters specific to the enterprise, and generating an interface model for the enterprise based on a second set of parameters specific to the enterprise. The method also includes dynamically constructing an enterprise application for the enterprise based on the business model and the interface model.

In another aspect, an apparatus includes a processor, and a memory coupled to the processor. The memory includes a general enterprise modeling module, stored in the form of executable program, which when executed by the processor, cause the processor to perform method steps described above.

In yet another aspect, a non-transitory computer-readable storage medium having instructions stored therein, that when executed by a computing device, cause the computing device to perform method steps described above.

Other features of the embodiments will be apparent from the accompanying drawings and from the detailed description that follows.

### BRIEF DESCRIPTION OF THE VIEWS OF THE DRAWINGS

FIG. 1 shows an example of a computing device for implementing one or more embodiments of the present subject matter.

FIG. 2 illustrates a block diagram of the general enterprise modeling module, according to one embodiment.

FIG. 3 illustrates a block diagram of the business modeling module, according to one embodiment.

FIG. 4 illustrates a block diagram of the interface modeling module, according to one embodiment.

FIG. 5 illustrates a block diagram of the enterprise application construction module, according to one embodiment.

FIG. 6 is a process flowchart illustrating an exemplary method of constructing an enterprise application specific to an enterprise, according to one embodiment.

FIG. 7 is a diagrammatic representation illustrating a general enterprise modeling system for dynamic construction of a customized enterprise application, according to one embodiment.

The drawings described herein are for illustration purposes only and are not intended to limit the scope of the present disclosure in any way.

### DETAILED DESCRIPTION

The present disclosure provides a method and system for method of dynamically constructing an enterprise application for an enterprise. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

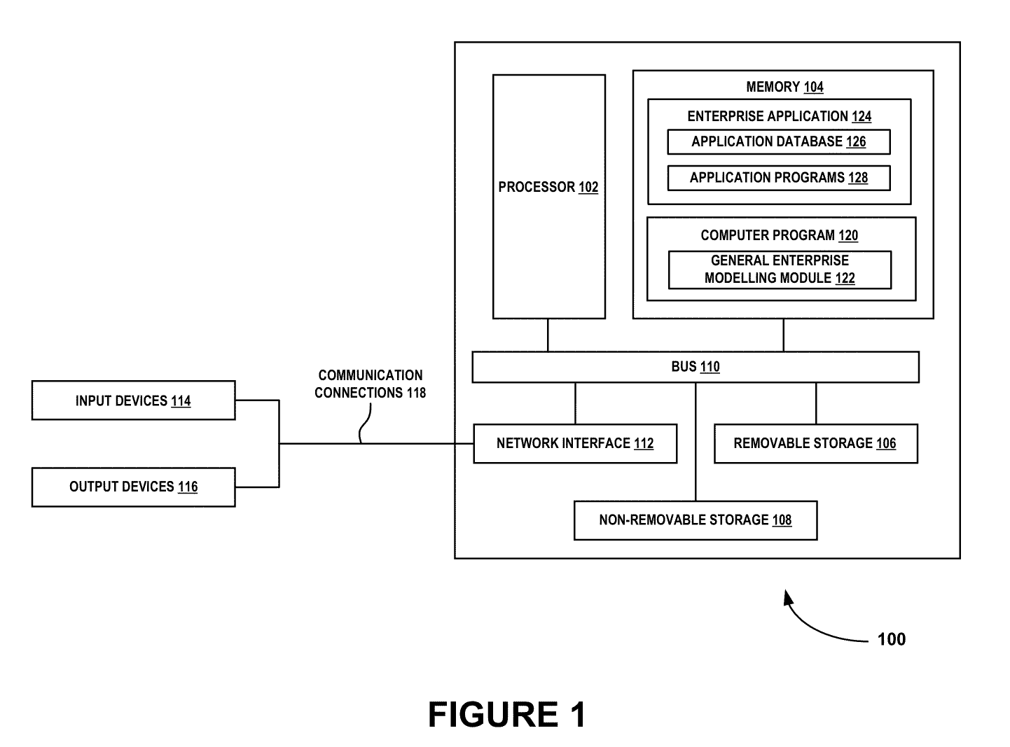

FIG. 1 shows an example of a computing device 100 for implementing one or more embodiments of the present subject matter. FIG. 1 and the following discussion are intended to provide a brief, general description of the suitable computing environment in which certain embodiments of the inventive concepts contained herein may be implemented.

The computing device 100 may include a processor 102, memory 104, a removable storage 106, and a non-removable storage 108. The computing device 100 additionally includes a bus 110 and a network interface 112. The computing device 100 may include or have access to one or more user input devices 114, one or more output devices 116, and one or more communication connections 118 such as a network interface card or a universal serial bus connection. The one or more user input devices 114 may be keyboard, mouse, and the like. The one or more output devices 116 may be a display, printer and the like. The communication connections 118 may include mobile networks such as Wireless Area Network (WAN) and Local Area Network (LAN), and the like.

The memory 104 may include volatile memory and/or non-volatile memory for storing computer program 120. A variety of computer-readable storage media may be stored in and accessed from the memory elements of the computing device 100, the removable storage 106 and the non-removable storage 108. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, external hard drives, memory sticks, memory cards and the like.

The processor 102, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 102 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and programs, for performing tasks, or defining abstract data types or low-level hardware contexts. Machine-readable instructions stored on any of the above-mentioned storage media may be executable by the processor 102 of the computing device 100. For example, a computer program 120 includes the general enterprise modeling module 122 stored in the form of machine readable instructions. The machine-readable instructions may cause the computing device 100 to construct an enterprise application 124 comprising an application database 126 and application programs 128, according to the various embodiments of the present subject matter. According to the present invention, the machine-readable instructions pertaining to the general enterprise modeling module 122 is executed by the processor 102, the processor 102 generates a business model specific to an enterprise based on a first set of parameters inputted by a user (e.g., General Enterprise Modeling Consultant) using input devices 114, generates an interface model confirming to requirements of the enterprise based on a second set of parameters inputted by the user using the input devices 114, and dynamically constructs a targeted enterprise application 124 based on the business model and the interface model specific to the enterprise. The processor 102 is also able to reconstruct enterprise application if one or more parameters of the first set of parameters and/or one or more parameters of the second set of parameters are changed over a period of operation of the enterprise.

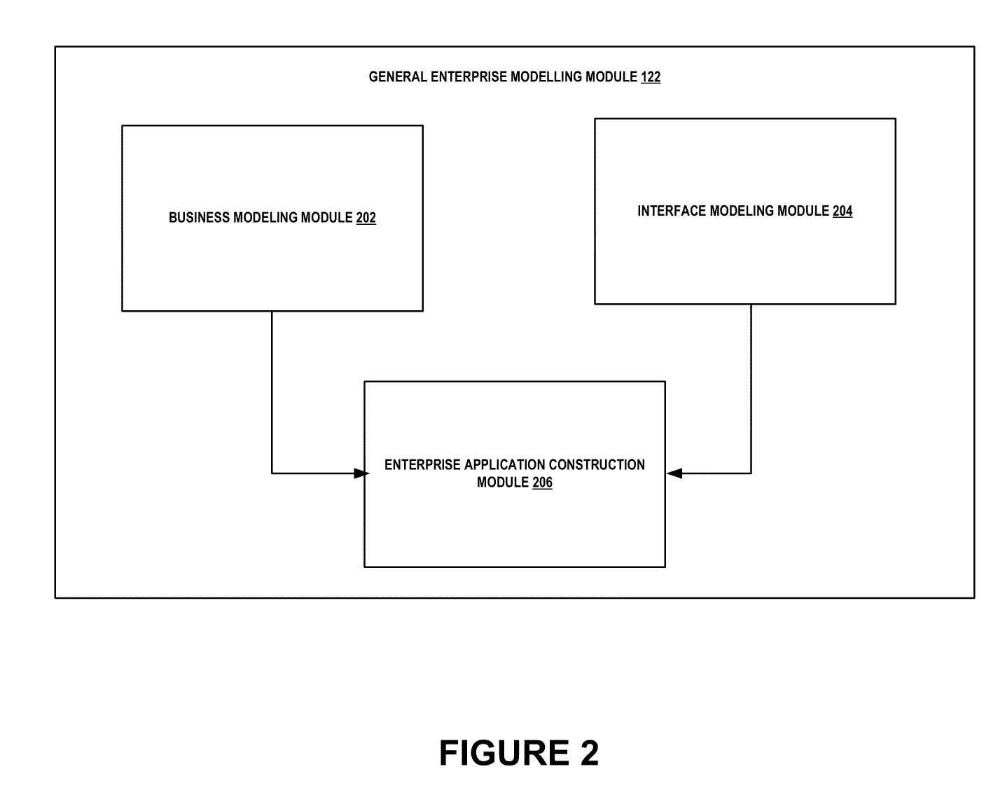

FIG. 2 illustrates a block diagram of the general enterprise modeling module 122, according to one embodiment. The general enterprise modeling module 122 includes a business modeling module 202, an interface modeling module 204, and an enterprise application construction module 206.

The business modeling module 202 is configured for generating a business model for an enterprise based on a first set of parameters specific to the enterprise. For example, the first set of parameters includes parameters related to organization structure, business objects, and business processes. The interface modeling module 204 is configured for generating an interface model for the enterprise based on a second set of parameters specific to the enterprise. For example, the second set of parameters includes parameters related to user interfaces, report objects, and business reports. The enterprise application construction module 206 is configured for dynamically constructing an enterprise application for the enterprise based on the business model and the interface model.

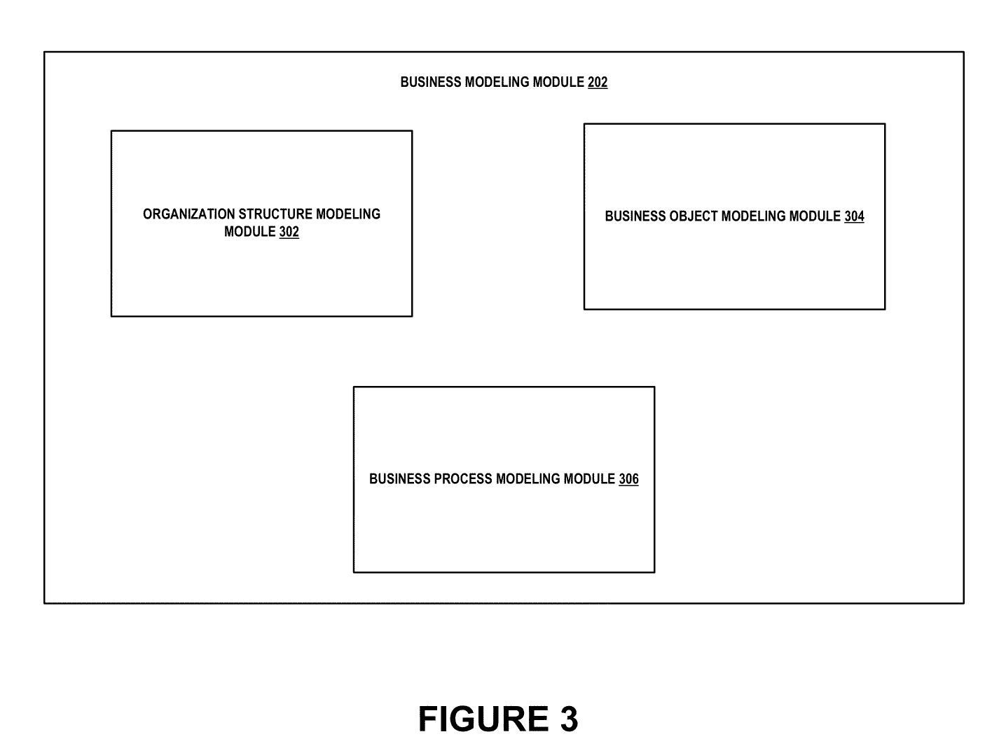

FIG. 3 illustrates a block diagram of the business modeling module 202, according to one embodiment. The business modeling module 202 includes an organization structure modeling module 302, a business object modeling module 304, and business process modeling module 306.

The organization structure modeling module 302 is configured for modeling organization structure of an enterprise based on the parameters associated with organization structure. An enterprise possesses a characteristic organizational structure based on which different functions are performed. The organization structure may include external organization structure such as supplier, customer, partner, financier, etc. and internal organization structure such as company, profit center, site, department, etc.

The organization structure modeling module 302 models the organization structure by creating organization structure objects and linking the organization structure objects in hierarchical tree structures (parent-child relationship) of any depth. The organization structure object is used to define organization structure of an enterprise such as a business group, company, profit center, site, department, cost center, section, employee, supplier, customer, partner, dealer, financier and the like. For example, actual companies contained in a business group are instances of an organization structure object called company. Similarly, actual departments in the company are instances of the organization structure object called departments. Further, the organization structure objects may have nested structures within themselves such as sub-department within a department. Furthermore, roles of organization structure objects are also included as members of organization structures. Additionally, roles of the organization structure objects may be instantiated as end users.

Every enterprise has its own unique way of organizing the organization structures to run business operations. Even naming of organization structures is unique to each enterprise. Hence, the organization structure modeling module 302 do not consider any fixed organization structure model that can fit all enterprises in a generalized manner. Rather, the organization structure modeling module 302 generates an organization structure model based on specific business functions and organizational requirements of the enterprise.

The organization structure modeling module 302 may model organization structure of an enterprise based on pre-defined rules. Exemplary pre-defined rules include maximum number of levels associated with organization structure hierarchies, instantiation of an organization structure implies instantiation of all its sub-organization structures and linked roles in organization structure tree, an organization structure may have multiple instances and roles and may be linked to any level in organization structure trees, the role may have multiple instances and so on.

The business object modeling module 304 is configured for modeling business objects of an enterprise based on the parameters related to the business objects. Business objects are conceptual instruments using which an enterprise business is operated. Business objects may have physical manifestations in enterprise in terms of money, materials or information as perceived by the enterprise. An enterprise operates through transactions involving transformation of one or more business objects. Such transformation may be in terms of birth or evolution or death of instances of business objects involved. The business object modeling module 304 models the business objects through creation and management of the business objects that are associated with fields holding data elements related to objects, properties (i.e., logical information derived from one or more or all fields, methods affecting transformations or modify the status of the business objects, roles of users managing the business objects, sub-objects (i.e., other embedded objects forming a logical part hierarchically) as well as inter and intra object relationships.

For example, fields associated with business objects may include singular fields (e.g., leaf-level fields containing data elements), structure fields (e.g., a list of singular and/or structure fields), collective fields (e.g., a multiplicity of singular or structure fields), and sub-object fields involving hierarchy of business objects. It can be noted that, hierarchy of fields is distinctly different from hierarchy of business objects.

Intra-object relationships may exist among various options of the business objects in the following ways:
a) Field-level relationships;
b) Cumulative value based with respect to a given control key relationships;
c) Individual quantity based relationships;
d) Number of instances based relationships;
e) Property level relationships; and
f) Value-based relationships.

Similarly, the field of a business object may have an inter-object referential relationship with another field of another object. Such relationships may be of any type, viz. one-to-one or one-to-many or many-to-one and helps in enforcing referential integrity between fields of two different business objects. The union of all business objects related through such inter-object referential relationships to a given business object is called the “referential object space” of that business object. The union of all fields within a referential object space of a business object is called the “referential field space” of that business object. The union of all instances of objects in the referential object space connected through such inter-object referential relationships to a specific instance of a business object is called the “referential object instance space” of that business object instance. Further, field instances in such a referential object instance space of a business object instance is called “referential field instance space” of that business object instance.

The business objects may further be broadly classified based on their everyday usage in the enterprise. The types include real business objects and virtual business objects. Real business objects are typically business objects that represent business instruments actually perceived by the enterprise and used in day-to-day business transactions. A business transaction is a transformation of one or more business objects into one or more new or evolved business objects. Examples of such objects include Bill of Materials, Material item, Chart of Accounts, purchase order, Invoice, Indent or the like.

Virtual business objects are also known as “derived business objects”. The virtual business objects are those business objects which are derived from a set of one or more real business objects to facilitate the definition of a complex business transaction. Virtual business objects may be associated with the following:
a. A real base business object;
b. A selected set of base properties which are a selected subset of properties of a base business object;
c. Zero or more foreign business objects;
d. Foreign properties which are a union of selected sets of properties of foreign objects; and
e. Derived properties which are derived from base properties and foreign properties.

The business object modeling module 304 provides facilities such as create and maintain singular fields, create and maintain structure fields as a list of singular fields or other structure fields or collective fields, create and maintain collective fields, as a multiplicity of singular fields or structure fields, create and maintain business objects, link business objects with singular fields or structure fields or collective fields or other business objects with parent child relationships to create business object hierarchies, link selected organization structures or selected instances of organization structures or selected roles or selected instances of roles (created through the OSM module 108) as owners of selected business objects, create and maintain properties associated with business objects, create and maintain sub-object relationships as field level or property level relationships among subordinates of a business object, create and maintain virtual business objects from a set of real business objects, create and maintain intra-object relationships, and create and maintain inter-object referential relationships of the business object with other business objects.

In some embodiments, the business object modeling module 304 models business objects based on a set of pre-defined rules. Exemplary rules may include all subordinates of a business object, i.e., singular fields, structure fields, collective fields, sub-objects and properties are unique to a given parent business object; if a business object subordinate is also applicable as a subordinate to another business object, the same has to be redefined with a different name and linked to the second business object; multiplicity of a collective field may be defined as “zero or more times” or “one or more times”; if an organization structure is linked as an owner of a business object, all instances of all roles linked to all instances of an organization structure will become owners of business object; if an instance of an organization structure is linked as an owner of a business object, all instances of all roles linked to that instance of the organization structure will become owners of business object; and if a role is linked as an owner of a business object, all instances of that role will become the owners of the business object.

Additionally, exemplary rules that apply to business objects with respect of business object hierarchies may include a business object can only be a singular subordinate to another business object: business object cannot be a part of a structure field or a collective field among subordinates of another business object; instantiation of a parent business object may not necessarily instantiate its child business object; child sub-object may be instantiated subsequent to parent object instantiation; and two instantiations may be part of two separate process steps as per business requirement. However, it may be noted that, this is not the case for field subordinates of a business object i.e., singular fields, structure fields and collective fields which are instantiated necessarily at the time of parent object instantiation.

The business process modeling module 306 is configured for modeling business process of an enterprise based on parameters related to the business process. A business process is a set of one or more process steps executed by various departments of the enterprise in a pre-defined manner, either serially or in parallel or a combination, and with a pre-defined sequence of execution and a predecessor/follower relationship among the process steps. Process steps may be triggered by mechanisms which are event-based, time-based and manual. Each process step consists of a set of inputs, a set of outputs, and business logic to transform the inputs into outputs. A business process may cut through various sites/departments/members to meet a specific objective. Each process step may be further defined as a set of transformations on one or more business objects.

Instances of process steps act on instances of stipulated business objects in order to transform them as defined. Such evolution of business objects is “value addition” process in businesses in practice. In practice, in the business operations of a process, an “instance of a process step” acts on the “instances of input business objects” in order to produce “instances of output business objects”. This phenomenon is called a “transaction”. Thus, business operations happen as a set of transactions. “Process steps” take a set of business objects as inputs and produce a set of business objects as outputs. Within a process step, business objects undergo “transformations” such as “birth” of an object instance, “evolution” of an object instance, and “death” of an object instance. Thus, “business value addition” happens through transformations of business object instances.

A process step may be viewed as a minimal work unit, which can be executed as part of business operations, without losing business operational consistency. In other words, the execution of any proper subset of a process step, would necessarily lead to business operational inconsistency. From this point of view, these process steps may be seen as “atomic” in nature (not divisible any further). Process steps are used to define a business process. Process steps are very important in actually formulating business rules and business logic.

A set of process steps executed by a department constitutes a ‘function’ of the department. While a process encompasses several departments, a function is performed by a specific department having expertise in doing it. Each process and each process step is owned by a role which takes responsibility for its success. Instances of process steps are nothing but business transactions being operated by instances of roles which are specific employees of the organization.

Each process step in a process involves a “service” offered by a “department” in the business. Thus, a process may cut across multiple departments in the business through its several process steps. The flow of process steps within a process is termed as “Business Process Choreography”. The set of services offered by a department, as part of the process steps of all processes of the business, is collectively termed as a “function” of that department.

The business process modeling module 306 facilitates modeling of business processes of an enterprise by creating and maintaining process steps; defining online input data; defining input business objects; defining output business objects; defining pre-transaction validations; defining business logics, with all possible error conditions and error messages; creating and maintaining predecessor and follower relationships between process steps; creating and maintaining business processes; linking process step as part of a business process; and linking role or instance of role as owner of process steps.

In some embodiments, the business process modeling module 306 models the business process using a pre-defined set of rules. Exemplary set of rules includes performing authorization checks (e.g., user must be one of owners of a process step and one of the owners of each one of output business objects), performing pre-transaction validations (e.g., verifying all preconditions of process step are satisfied), and executing business logic (e.g., refer to specific existing instances of each of the input business objects and their referential field instance space, and perform predefined computation and create new instances or modify the existing instances of the output business objects).

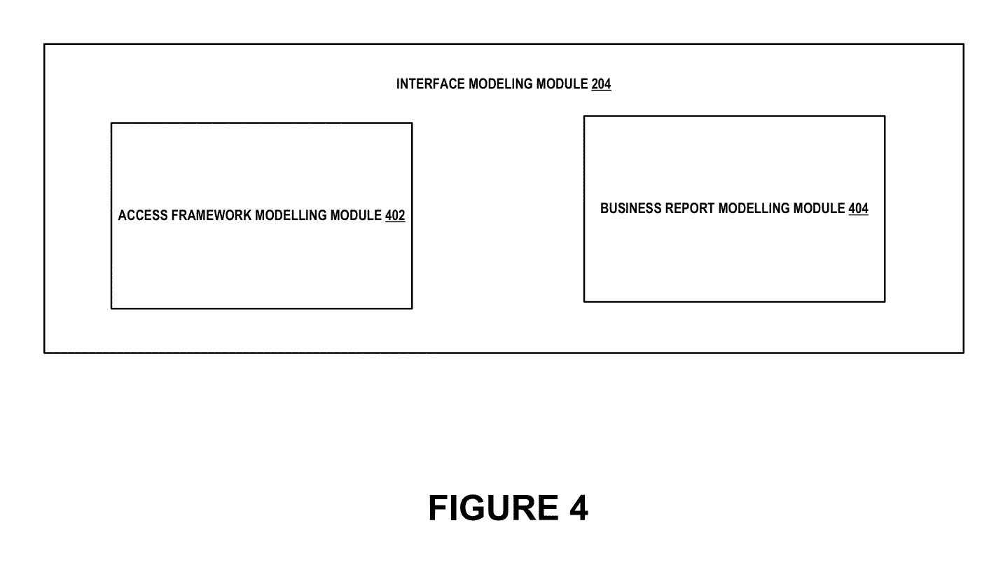

FIG. 4 illustrates a block diagram of the interface modeling module 204, according to one embodiment. The interface modeling module 204 includes an access framework modeling module 402, and a business report modeling module 404.

The access framework modeling module 402 is configured for modeling an access framework based on parameters related to user interfaces. The access framework includes a menu tree which spreads its branches over several levels of hierarchy below its root. The leaf nodes of the menu tree lead to and bear a one-to-one correspondence to functional levels of user interfaces known as “functional user interfaces”. Each functional user interface is a chain of screen interfaces invoked in a certain order to affect a logical transaction of an enterprise application. A functional user interface may embed a set of other functional user interfaces invoked within its execution. However, a functional user interface may not invoke itself in a recursive manner as such recursive invocations may not result any operational convenience and yet could be very confusing to users. Each functional user interface is represented as a chain of screen interfaces invoked in a certain order to affect a logical transaction of the enterprise application. A functional user interface may embed a set of other functional user interfaces invoked within its execution.

Each screen interface includes a set of screen objects. For example, screen object types may include screen window objects, screen tab objects, screen action objects, screen data objects, and screen link objects. Screen window objects can be seen as sub-screens which indicate logical subsets of the screen interface. However, entry to and exit from the screen interfaces may be based on clicking of some screen link objects within a parent screen interface. Screen window objects can be modal or modeless. Screen tab objects indicate tabs within a parent screen interface. Screen data objects include fields of numeric or text or other (flag etc.) types of data. These objects may be any of the types including entry field, selection field, combo field, check-box or radio-button. Screen action objects are buttons which when clicked may complete a well-defined action in the form of executing a specific process step or a specific report step and return to the screen. Screen link objects are those objects which when clicked may lead to a new screen interface or a window object either in a returnable or non-returnable manner.

The access framework modeling module 402 defines an access framework for an end user to access an enterprise application. For example, the access framework modeling module 402 includes a login facility for an end user to use user identifier and password to login to the enterprise application and a menu system that guides the user to a specific process step execution to affect a business transaction or to a specific report step execution to generate a business report. Login is an initial activity executed by a user in order to obtain access to an application. The login activity triggers execution of a special process step called “Login step” which refers to a special business object called “Login object” and a special screen object called “Login screen”. Clicking the login action button leads the user to the menu system after password verification. The menu system works in a similar way executing special process steps known as “menu steps” based on special business objects known as “Menu objects” which refer to special screen objects known as “menu screens”. Initially, when the user is lead from the login system to the menu system, an initial menu step is executed. Further, as the user selects his menu options, the menu system executes further menu steps, process steps, or report steps as per the definition of the menu system.

The access framework modeling module 402 creates and maintains screen interfaces of any of the following types such as screen action objects, screen data objects, screen link objects; links process steps or report steps to screen action objects for execution when clicked: links business objects fields (singular field or collective field) to screen data objects for online screen data capture and update purposes; creates and maintains screen window objects and screen tab objects; links screen action objects or screen data objects or screen link objects as part of selected screen window objects or screen tab objects; links screen tab objects as part of screen window objects; creates functional interfaces; links screen window objects as part of functional interfaces; creates functional menus; creates functional menu hierarchies through linking a selected functional menu as part of another functional menu, wherein the highest level of functional menu may be called the “Main Functional Menu”. which will not have a parent and which can be reached only through a special screen object known as “Login screen object”; and links functional interfaces as part of functional menu.

In some embodiments, the access framework modeling module 402 models access framework based on a set of pre-defined rules. Exemplary rules include
a) multiple functional menus created in the application, connected in hierarchical tree structures, with “Main Functional Menu at its root, a functional menu may have either other functional menus or screen window objects as its children;
b) screen window objects are of two types, i.e., parent screen window objects and leaf screen window objects;
c) parent screen window objects may have other screen window objects as their children, which creates hierarchies, however, they cannot have screen tab objects or screen action objects or screen data objects or screen link objects as their children;
d) similarly leaf screen window objects only have screen tab objects or screen action objects or screen data objects or screen link objects as their children, however, they will not have other screen window objects as their children;
e) screen tab objects or screen action objects or screen data objects or screen link objects cannot have hierarchies i.e., they cannot have children of any kind;
f) each screen action object is linked to a selected process step or a report step for execution when clicked;
g) each screen data field is linked to a business object field (singular field or collective field) for online screen data capture and update purposes;
h) each screen link object will provide a link to immediate parent screen window, to main functional menu or to logout the user.

The business report modeling module 404 is configured for modeling business report of an enterprise based on the parameters related to business reports. In one embodiment, the business report modeling module 404 is configured for capturing information requirements of the enterprise in the form of “Report Objects”. The information requirements may include information fields, derived fields such as totals, averages etc. and their presentation details including structure, position, fonts, size, colors, backgrounds and other presentation characteristics. The report objects are specifically designed for representing business report requirements for display or hardcopy printing. Typically, each report object may have report header at the beginning of a report, a page header, a page break, info item, control break, page trailer, and report trailer. Each of the above mentioned elements may have “fixed part” and a “variable part” resolved at the time of report step execution. Typically, report objects are derived objects and have flat structures (i.e., have no hierarchical structures).

The business report modeling module 404 creates and maintains business report objects with the above mentioned elements; define and detail each field of each one of the above mentioned elements of the business report objects in terms of type of field such as numeric, alphanumeric or other, fixed or variable field; in case of fixed fields, the field must be assigned a fixed value; all presentation details such as font type, font size, color, background, bold, underline etc.; and positioning of the field in the report structure; define control break conditions.

The business report modeling module 404 creates business report objects based on a set of pre-defined rules. Exemplary rules may include report objects have substantially flat structure of child elements (Report object->Component->Line->Field) and no further levels of hierarchies are possible; any number of lines with any number of fields within each line may be defined as part of each of the report object components i.e., Report header, Page header, Page break, Info item, Control break, Page trailer and Report trailer; the fields in business report objects must be singular only and thus cannot be collective or structure or sub-object fields; any field of the report object may be either fixed or variable: the value of fixed field is specified at the time of its definition as a fixed value or as a system parameter such as system date, page number etc.; and the variable fields of the business report object are resolved at the time of business report object instantiation during the related report step execution time.

In another embodiment, the business report modeling module 404 facilitates process of extracting data from business objects for creating business report objects for business reporting purposes known as “report steps”. Thus, report steps are like process steps where the output objects include report objects. The business report modeling module 404 creates and maintains report steps: define online input data; define input business objects; define output business report objects; define pre-transaction validations; and define business logics, with all possible error conditions and error messages.

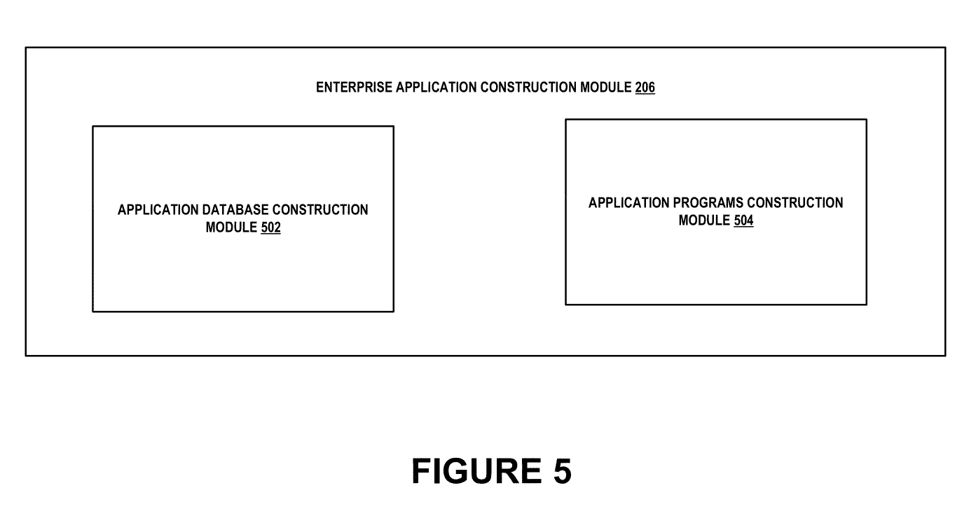

FIG. 5 illustrates a block diagram of the enterprise application construction module 206, according to one embodiment. The enterprise application construction module 206 includes application database construction module 502 and application programs construction module 504.

The application database construction module 502 is configured for constructing an application database (e.g., application database 126 of FIG. 1) for a desired enterprise application (e.g., the enterprise application 124 of FIG. 1) for the enterprise. In some embodiments, the application database construction module 502 is configured for constructing an application database for the desired enterprise application by processing the business model and the interface model and generating a final schema design and database of the desired enterprise application.

The application program construction module 504 is configured for constructing application programs (e.g., application programs 128 of FIG. 1) constituting the desired enterprise application based on the business model, and the interface model. In some embodiments, the application program construction module 504 is configured for constructing application programs for the desired enterprise application by processing the business model and the interface model and generating final programs for the desired enterprise application. For example, the application program construction module 504 constructs coded programs corresponding to the desired enterprise application including but not limited to programs to implement business process steps, programs to implement menus, functional user interfaces and other screen objects, and programs to implement business reports.

The output of the enterprise application construction module 206 may include application programs 128 constructed by the application programs construction module 504, constituting a customized enterprise application 124 which is designed to run using application database 126 constructed by the application database construction module 502.

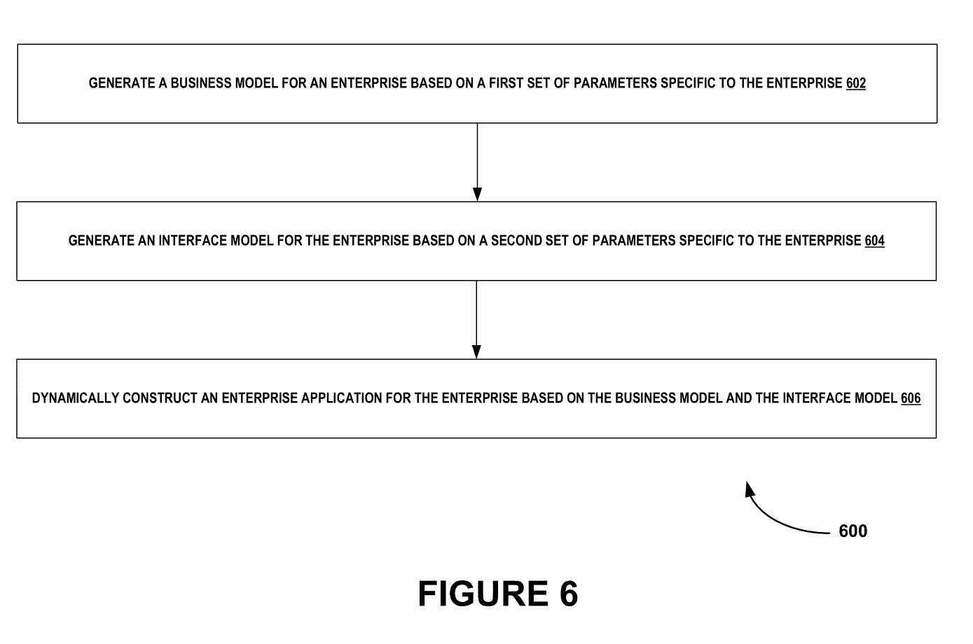

FIG. 6 is a process flowchart 600 illustrating an exemplary method of constructing an enterprise application specific to an enterprise, according to one embodiment. At step 602, business model for an enterprise is generated based on a first set of parameters specific to the enterprise. The step of generating a business model may involve modeling organization structures, modeling of business objects and modeling of business processes associated with the enterprise. For example, the step of modeling organization structures includes studying and capturing organization structures of an enterprise, defining organization structure hierarchies, defining functional roles, and defining users as instances of functional roles. Further, the step of modeling business objects includes studying and capturing business objects of the enterprise, defining business object hierarchies, and defining detailed properties and methods of all business objects. The step of modeling business processes includes studying and capturing business processes of the enterprise, defining process steps within each business process, defining input and output business objects of each business step, defining business logic of each process step, defining validations and business rules for each process step, and linking process steps to business processes with predecessor and follower relationships.

At step 604, an interface model for the enterprise is generated based on a second set of parameters specific to the enterprise. The interface model is generated by modeling an access framework and modeling business report/query formats and modeling report/query needs for the enterprise. For example, the step of modeling report or query formats includes studying and capturing details of user business reports/queries, and defining detailed formats of each report/query. The step of modeling report or query needs includes studying and capturing detailed business report/query requirements, and defining report steps with full details of report/query needs. The step of modeling access framework includes studying and capturing details of application access for users, defining login screen, highest level menu and other sub-menus of the enterprise application, defining detailed screens for process step execution and linking them to menu options as well as process steps, and defining detailed screens for running queries/reports and linking them to menu options as well as report steps.

At step 606, a desired enterprise application is dynamically constructed based on the business model and the interface model for the enterprise. The enterprise application is dynamically constructed by constructing application database and application programs based on the business model and the interface model of the enterprise.

The customized enterprise application is then tested and implemented. The step of testing and implementing the enterprise application includes:
a) moving application programs and application databases to a quality testing system;
b) running and testing the enterprise application in the quality testing system;
c) when the enterprise application is found to be confirming to all business requirements, moving the application programs and databases to a production system.

If the enterprise application is to be modified to confirm with current business requirements, a modified business model is generated based on modified parameters in the first set of parameters, a modified interface model is generated based on modified parameters in the second set of parameters, and an enterprise application is re-constructed based on the modified business model and the modified interface model.

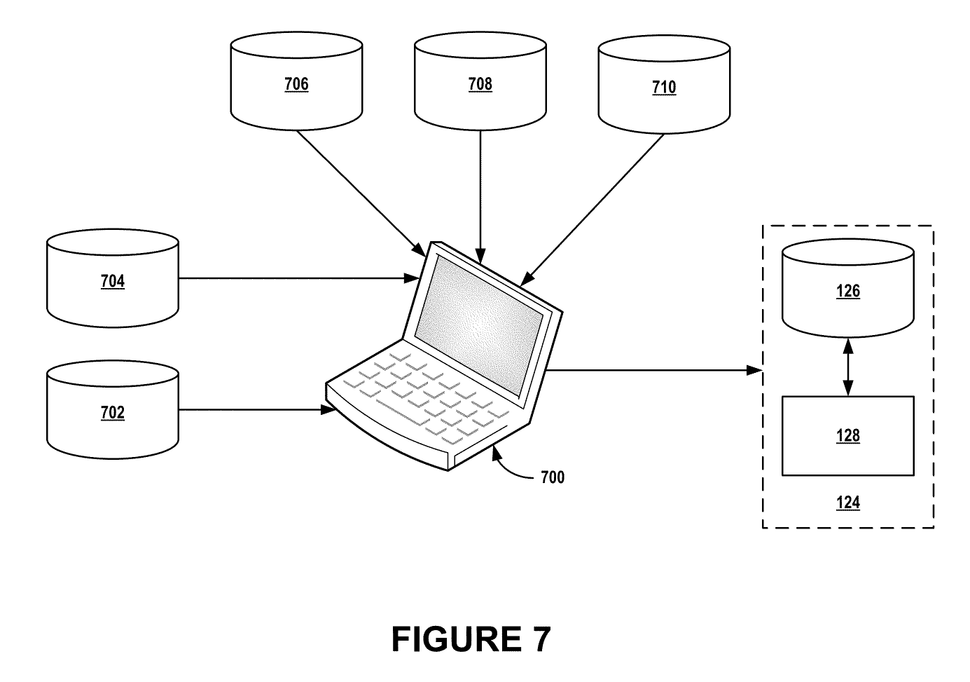

FIG. 7 is a diagrammatic representation illustrating a general enterprise modeling system 700 for dynamic construction of a customized enterprise application, according to one embodiment. It is appreciated that the general enterprise modeling system 100 is an exemplary embodiment of the computing device 100 in FIG. 1. In FIG. 7, the general enterprise modeling system 100 includes an organization structure database 702, a business object database 704, a business process database 706, an access framework database 708, a business report database 710, an application database 126, and application programs 128.

The organization structure database 702 stores organization structure related requirements associated with an enterprise. The business object database 704 stores business objects related requirements of the enterprise. The business process 706 stores business process related requirements of the enterprise. The access framework database 708 stores functional user interfaces, menus and screen objects related requirements of the enterprise. The business report database 710 stores business report objects and report steps related requirements of the enterprise. By accessing the databases containing requirements of the enterprise as specified by a consultant, the general enterprise modeling system 700 constructs an enterprise application 124 containing application database 126 and application programs 128 and stores the application database 124 and the application programs 128.

Consider that an owner of an enterprise wishes to have a trading business application (i.e., customized enterprise application). Also, consider that the enterprise deals with categories such as fresh vegetables, packed foods, house hold goods, kitchen tools, toilet items, and cosmetics.

Further, the enterprise employs a business manager, Inventory manager, Customer manager and Accounts manager. The business manager is assigned a role of business planning, purchase ordering, and cash flow planning. The inventory manager is assigned role of receiving goods, binning, tracking inventory movement etc. The customer manager is assigned is customer order taking, picking, packing, delivery, and billing. The accounts manager is assigned a role of handling vendor bill payments, customer payment collections, and accounts management. Therefore, the organization structure of the enterprise includes business manager, customer manager, accounts manager, and inventory manager.

Furthermore, the enterprise involves following business processes:
1) Procurement—Purchase ordering, receipt of goods from vendors, payment to vendors, etc.;
2) Sales—Over the counter (OTC) sales including customer order taking, picking of items, packing, delivery, billing, payment collection; and
3) Inventory management—Bin received goods, Issue goods to customers, monthly physical inventory taking.

A general enterprise modeling (GEM) consultant obtains the above information from the owner of the enterprise and creates an analysis of parameters as shown in Table 1.

| Organizational | | | |
|---|---|---|---|
| Structure | Business Object | Business Process | Business Report |
| Business | Business Plan | Set business targets | Cash flow statement |
| Manager | | | Business analysis |
| | | | Profitability Statement |
| | | | Business summary |
| Accounts | Accts master | Maintain Accounts | Vendor SOA |
| Manager | General Ledger | Make vendor payment | Customer SOA |
| | | Collect customer | Vendor Outstanding |
| | | payment | Customer outstanding |
| | | Post special expenses | General Ledger |
| Inventory | Material master | Maintain material item | Purchases register |
| Manager | Vendor master | Maintain vendor | Stock register |
| | Material price | Maintain PO | Material movement |
| | Purchase order | Receive materials | report |
| | Goods Receipt | Process vendor bill | Purchase Order |
| | Vendor Bill | | |
| | Material stock | | |
| | Material movement | | |
| Customer | Customer master | Maintain customer | Sales register |
| Manager | Sale Order | Make OTC sale | Sale Order |
| | Customer invoice | Make sale order | |
| | | Make delivery | |
| | | Make customer invoice | |

The general enterprise modeling module 120 provides user interface to the GEM consultant to input the set of parameters associated with organizational structure, business object, business process, user interface, and business reports. Based on the inputs provided by the GEM consultant, the general enterprise modeling module 120 generates business model and interface model. For example, the business model may define the linkages between the organization structure, the business processes and the business objects specified by the GEM consultant. Also, the interface model may include defining detailed screens for process step execution and linking them to menu options as well as process steps, and defining detailed screens for running queries/reports and linking them to menu options as well as report steps. Further, the general enterprise modeling module 120 constructs an enterprise application based on the business model and the interface model specific to the enterprise. For example, the enterprise application is specific to the requirements of the enterprise. It can be appreciated that there is no need to re-write a software code to construct an enterprise application separately for each enterprise. Instead, the general enterprise modeling module 120 is capable of dynamically constructing the enterprise application from available application programs based on the requirement/parameters provided by the GEM consultant through an user interface for constructing enterprise applications.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A computer implemented method of dynamically constructing an enterprise application for an enterprise, comprising:
generating, using a processor, a business model for an enterprise based on a first set of parameters specific to the enterprise;
generating, using a processor, an interface model for the enterprise based on a second set of parameters specific to the enterprise; and
dynamically constructing, using a processor, an enterprise application for the enterprise based on the business model and the interface model.

2. The method of claim 1, wherein the first set of parameters comprises parameters related to organization structure, business objects, and business processes.

3. The method of claim 1, wherein the second set of parameters comprises parameters related to user interfaces and business reports.

4. The method of claim 1, wherein generating the business model for the enterprise based on the first set of parameters specific to the enterprise comprises:
modeling organization structure of the enterprise based on the parameters related to the organization structure;
modeling business objects of the enterprise based on the parameters related to the business objects; and
modeling business processes of the enterprise based on the parameters related to the business processes.

5. The method of claim 1, wherein generating the interface model for the enterprise based on the second set of parameters specific to the enterprise comprises:
modeling an access framework for accessing the enterprise application based on the parameters related to user interfaces; and
modeling business reports based on the parameters related to the business reports.

6. The method of claim 1, wherein automatically constructing the enterprise application for the enterprise based on the business model and the interface model comprises:
constructing an application database for a desired enterprise application for the enterprise based on the business model, and the interface model; and
constructing application programs constituting the desired enterprise application based on the business model, and the interface model.

7. The method of claim 1, further comprising:
modifying the business model associated with the enterprise based on modified parameters in the first set of parameters.

8. The method of claim 1, further comprising:
modifying the user interface model associated with the enterprise based on modified parameters in the second set of parameters.

9. The method of claims 7 and 8, further comprising:
dynamically reconstructing the enterprise application for the enterprise based on at least one of the modified business model and the modified user interface model.

10. An apparatus comprising:
a processor; and
a memory coupled to the processor, wherein the memory includes a general enterprise modeling module, stored in the form of executable program, which when executed by the processor, cause the processor to perform method steps comprising:
generating a business model for an enterprise based on a first set of parameters specific to the enterprise;
generating an interface model for the enterprise based on a second set of parameters specific to the enterprise; and
dynamically constructing an enterprise application for the enterprise based on the business model and the interface model.

11. The apparatus of claim 10, wherein the first set of parameters comprises parameters related to organization structure, business objects, and business processes.

12. The apparatus of claim 10, wherein the second set of parameters comprises parameters related to user interfaces and business reports.

13. The apparatus of claim 10, wherein in generating the business model for the enterprise based on the first set of parameters specific to the enterprise, the general enterprise modeling module cause the processor to perform the following steps comprising:
modeling organization structure of the enterprise based on the parameters related to the organization structure;
modeling business objects of the enterprise based on the parameters related to the business objects; and
modeling business processes of the enterprise based on the parameters related to the business processes.

14. The apparatus of claim 10, wherein in generating the interface model for the enterprise based on the second set of parameters specific to the enterprise, the general enterprise modeling module cause the processor to perform the following steps comprising:
modeling an access framework for accessing the enterprise application based on the parameters related to user interfaces; and
modeling business reports based on the parameters related to the business reports.

15. The apparatus of claim 10, wherein in automatically constructing the enterprise application for the enterprise based on the business model and the interface model, the general enterprise modeling module cause the processor to perform the following steps comprising:
constructing an application database for a desired enterprise application for the enterprise based on the business model, and the interface model; and
constructing application programs constituting the desired enterprise application based on the business model, and the interface model.

16. The apparatus of claim 10, wherein the general enterprise modeling module cause the processor to perform the following steps comprising:
modifying the business model associated with the enterprise based on modified parameters in the first set of parameters.

17. The apparatus of claim 10, wherein the general enterprise modeling module cause the processor to perform the following steps comprising:
modifying the user interface model associated with the enterprise based on modified parameters in the second set of parameters.

18. The apparatus of claims 16 and 17, wherein the general enterprise modeling module cause the processor to perform the following steps comprising:
dynamically reconstructing the enterprise application for the enterprise based on at least one of the modified business model and the modified user interface model.

19. A non-transitory computer-readable storage medium having instructions stored therein, that when executed by a computing device, cause the computing device to perform method steps comprising:
generating a business model for an enterprise based on a first set of parameters specific to the enterprise;
generating an interface model for the enterprise based on a second set of parameters specific to the enterprise; and
dynamically constructing an enterprise application for the enterprise based on the business model and the interface model.
